(19) United States
(12) Patent Application Publication
(10) Pub. No.: US 2026/0353212 A1
(43) Pub. Date: Nov. 5, 2026

(54) ROBUST HO VIA SL RELAYS

(71) Applicant: InterDigital Patent Holdings, Inc., Wilmington, DE (US)

(72) Inventors: Oumer Teyeb, Montreal (CA); Martino M. Freda, Laval (CA); Tuong Duc Hoang, Montreal (CA); Ananth Kini, Conshohocken, PA (US)

(73) Assignee: InterDigital Patent Holdings, Inc., Wilmington, DE (US)

(21) Appl. No.: 19/116,460

(22) PCT Filed: Sep. 28, 2023
(86) PCT No.: PCT/US2023/033987

§ 371 Date: Mar. 28, 2025

Related U.S. Application Data
(60) Provisional application No. 63/410,937, filed on Sep. 28, 2022.

(51) Int. Cl. H04W 36/00; H04W 76/14; H04W 88/04

(52) U.S. Cl. CPC H04W 36/03; H04W 36/0058; H04W 76/14; H04W 88/04

(57) ABSTRACT

Systems, methods, and instrumentalities are disclosed herein associated with robust handover (HO) via sidelink (SL) relays. A remote wireless transmit/receive unit (WTRU) may be used in HO scenario from a source network node (e.g., gNB) to a neighbor or target network node (e.g., gNB). For example, the HO procedure may include a remote WTRU determining whether condition(s) (e.g., measurement reporting condition or sidelink connection establishment condition (e.g., event condition)) are satisfied. The remote WTRU may establish a sidelink connection with a relay candidate, for example, during the HO procedure.

### CROSS-REFERENCE TO RELATED APPLICATIONS

This application claims the benefit of Provisional U.S. Patent Application No. 63/410,937, filed Sep. 28, 2022, the disclosure of which is incorporated herein by reference in its entirety.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE). Wireless communication devices may establish communications with other devices and data networks, e.g., via an access network, such as a radio access network (RAN).

### SUMMARY

Systems, methods, and instrumentalities are disclosed herein associated with robust handover (HO) via sidelink (SL) relays. A remote wireless transmit/receive unit (WTRU) may be used in HO scenario from a source network node (e.g., gNB) to a neighbor or target network node (e.g., gNB). For example, the HO procedure may include a remote WTRU determining whether condition(s) (e.g., measurement reporting condition or sidelink connection establishment condition (e.g., event condition)) are satisfied. The remote WTRU may establish a sidelink connection with a relay candidate, for example, during the HO procedure.

The remote WTRU may receive configuration information for performing HO via SL relays. The configuration information may include a measurement reporting condition and/or a sidelink connection establishment condition (e.g., event condition). The measurement reporting condition may be associated with a radio measurement quality (e.g., reference signal received power (RSRP) or reference signal received quality (RSRQ)) between the remote WTRU and the source network node and/or a radio measurement quality (RSRP, RSRQ) between the remote WTRU and the target network node. The measurement reporting condition may be satisfied, for example, if the RSRP/RSRQ associated with the target (e.g., neighboring) network node is greater than the RSRP/RSRQ associated with the source network node. The measurement reporting condition may be satisfied, for example, if an aggregate RSRP/RSRQ associated with the target network node is greater than an aggregate RSRP/RSRQ associated with the source network node. The measurement reporting condition may be satisfied, for example, if a signal level associated with the source network node is less than a first threshold and a signal level associated with the target network node is greater than a second threshold. The sidelink connection establishment condition may be associated with a sidelink RSRP (SL-RSRP). For example, the sidelink connection establishment condition may be satisfied based on a determination that the SL-RSRP is greater than a threshold.

The remote WTRU may determine that the measurement reporting condition(s) is satisfied. Based on a determination that the measurement reporting condition(s) is satisfied, the remote WTRU may send a measurement report to the source network node. Based on the determination that the measurement reporting condition(s) is satisfied, the remote WTRU may establish a sidelink connection (e.g., PC5 connection) with one or more relay WTRUs that satisfy the sidelink connection establishment condition. The remote WTRU may receive a handover command, for example, via the relay WTRU (e.g., one of the relay WTRUs). The handover command may indicate a target network node. The WTRU may establish a connection associated with the target network node, for example, based on the handover command. The remote WTRU may send (e.g., to the target network node) an indication that indicates that the handover reconfiguration is complete. The indication may be sent via the relay WTRU.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 shows an example of a handover (HO) scenario in new radio (NR).

FIG. 3 shows an example conditional handover configuration and execution.

FIG. 4 shows an example user plane protocol stack for L2 WTRU-to-network relay.

FIG. 5 shows an example control plane protocol stack for L2 WTRU-to-network relay.

FIG. 6 shows an example procedure for a U2N remote WTRU switching to a direct Uu cell.

FIG. 7 shows an example procedure for a U2N remote WTRU switching to an indirect path.

FIG. 8 shows an example HO from a direct or indirect link from a source gNB to an indirect link of another gNB.

FIG. 9 shows an example of sending an HO command via the target relay WTRU.

FIG. 10 shows an example flow of HO based on a measurement reporting event and an event condition.

### DETAILED DESCRIPTION

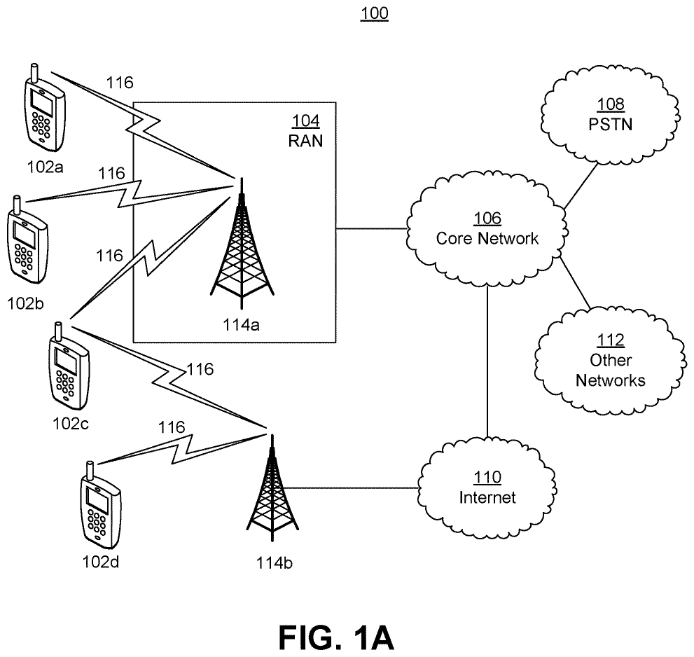

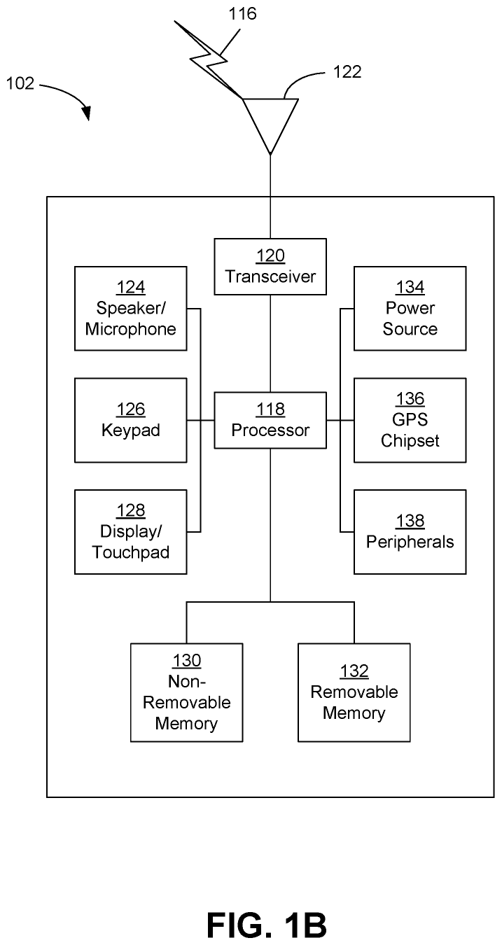

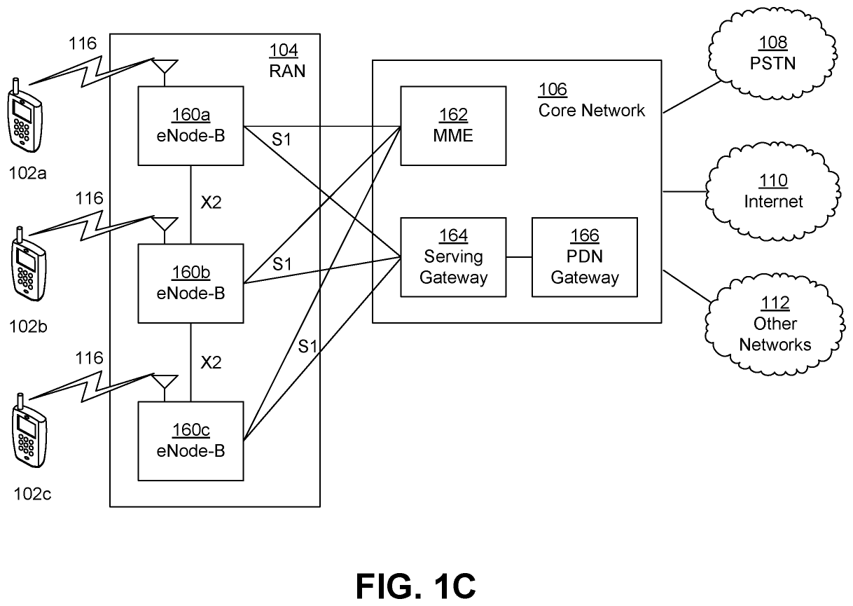

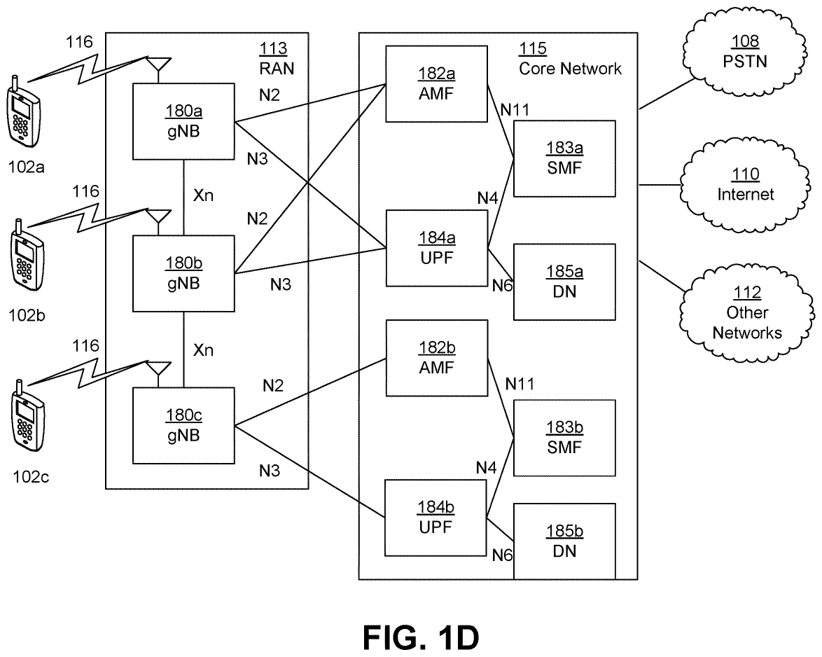

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an encode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are disclosed herein associated with robust handover (HO) via sidelink (SL) relays. A remote wireless transmit/receive unit (WTRU) may be used in HO scenario from a source network node (e.g., gNB) to a neighbor or target network node (e.g., gNB). For example, the HO procedure may include a remote WTRU determining whether condition(s) (e.g., measurement reporting condition or sidelink connection establishment condition (e.g., event condition)) are satisfied. The remote WTRU may establish a sidelink connection with a relay candidate, for example, during the HO procedure.

The remote WTRU may receive configuration information for performing HO via SL relays. The configuration information may include a measurement reporting condition and/or a sidelink connection establishment condition (e.g., event condition). The measurement reporting condition may be associated with a radio measurement quality (e.g., reference signal received power (RSRP) or reference signal received quality (RSRQ) between the remote WTRU and the source network node and/or a radio measurement quality (RSRP, RSRQ) between the remote WTRU and the target network node. The measurement reporting condition may be satisfied, for example, if the RSRP/RSRQ associated with the target (e.g., neighboring) network node is greater than the RSRP/RSRQ associated with the source network node. The measurement reporting condition may be satisfied, for example, if an aggregate RSRP/RSRQ associated with the target network node is greater than an aggregate RSRP/RSRQ associated with the source network node. The measurement reporting condition may be satisfied, for example, if a signal level associated with the source network node is less than a first threshold and a signal level associated with the target network node is greater than a second threshold. The sidelink connection establishment condition may be associated with a sidelink RSRP (SL-RSRP). For example, the sidelink connection establishment condition may be satisfied based on a determination that the SL-RSRP is greater than a threshold.

The remote WTRU may determine that the measurement reporting condition(s) is satisfied. Based on a determination that the measurement reporting condition(s) is satisfied, the remote WTRU may send a measurement report to the source network node. Based on the determination that the measurement reporting condition(s) is satisfied, the remote WTRU may establish a sidelink connection (e.g., PC5 connection) with one or more relay WTRUs that satisfy the sidelink connection establishment condition. The remote WTRU may receive a handover command, for example, via the relay WTRU (e.g., one of the relay WTRUs). The handover command may indicate a target network node. The WTRU may establish a connection associated with the target network node, for example, based on the handover command. The remote WTRU may send (e.g., to the target network node) an indication that indicates that the handover reconfiguration is complete. The indication may be sent via the relay WTRU.

A remote WTRU may be configured to receive the HO command either from the source or from the target gNB via a target U2N SL relay WTRU. The remote WTRU may configured to trigger the establishment of a PC5 connection towards one or more relay WTRUs, based on the fulfillment of a condition (e.g., measurement report to the source gNB triggered that includes a particular relay WTRU, the SL RSRP towards a certain relay WTRU is greater than a certain threshold, etc.). The remote WTRU may be configured to send an indication to the relay WTRU (e.g., during the PC5 establishment), which informs the relay WTRU to trigger a connection radio resource control (RRC) resume or setup towards the target gNB. the target relay WTRU may trigger an RRC SETUP or RESUME (e.g., if it was not in CONNECTED mode), based on the reception of an indication from the remote WTRU to do so (e.g., during PC5 establishment). The target relay WTRU may receive a message from the target gNB (e.g., RRC message) that includes the HO command for the remote WTRU in a transparent container, and the relay WTRU forwarding it to the remote WTRU via the PC5 link (e.g. using PC5-RRC). The target relay WTRU may trigger the establishment of the PC5 connection towards the remote WTRU based on an indication of the remote WTRU's identity, e.g., L2 identity (e.g., which may be included in the message containing the HO command to the remote WTRU that was received from the target gNB.)

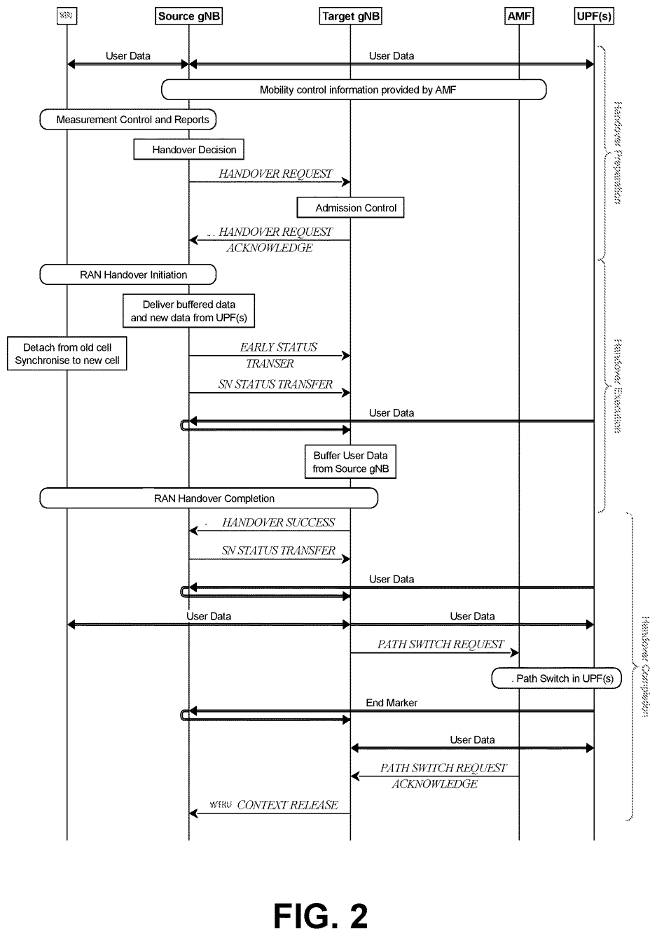

FIG. 2 shows an example of a handover (HO) scenario in new radio (NR). The WTRU context within the source base station (e.g., source gNB) may include information regarding roaming and access restrictions which were provided either at connection establishment or at the last timing advance (TA) update. The source gNB may send configuration information to (e.g., configure) the WTRU indicating measurement procedures. The WTRU may report, for example, based on the measurement configuration. The source gNB may (e.g., decide to) handover the WTRU based on the received measurements.

The source gNB may issue a handover request message to the target gNB, for example, passing a transparent RRC container with information to prepare the handover at the target side. The information may include one or more of the following: the target cell ID; KgNB*; the C-RNTI of the WTRU in the source gNB; RRM-configuration including WTRU inactive time; basic AS-configuration including antenna information and DL carrier frequency; the current QoS flow to Data Radio Bearer (DRB) mapping rules applied to the WTRU; the SIB1 from the source gNB; the WTRU capabilities for different RATs; PDU session related information; or the WTRU reported measurement information including beam-related information if available. Admission control may be performed by the target gNB. The target gNB may prepare the handover with L1/L2 and may send the HANDOVER REQUEST ACKNOWLEDGE to the source gNB (e.g., which may includes a transparent container to be sent to the WTRU as an RRC message to perform the handover), for example, if the WTRU is admitted. The source gNB may trigger the Uu handover by sending a message (e.g., an RRCReconfiguration) message to the WTRU, for example, that may indicate (e.g., contain) the information used (e.g., required) to access the target cell, which may include one or more of the following: the target cell ID; the C-RNTI; or the target gNB security algorithm identifiers for the selected security algorithms. It may include a set of dedicated Random Access Channel (RACH) resources, the association between RACH resources and SSB(s), the association between RACH resources and WTRU-specific CSI-RS configuration(s), common RACH resources, system information of the target cell, etc. The source gNB may send a message (e.g., a SN STATUS TRANSFER message) to the target gNB, for example, to convey the uplink packet data convergence protocol (PDCP) Sequence Number (SN) receiver status and the downlink PDCP SN transmitter status of DRBs for which PDCP status preservation applies (e.g., for RLC AM). The WTRU may synchronize to the target cell and complete handover (e.g., the RRC handover procedure), for example, by sending a message (e.g., an RRCReconfigurationComplete message) to the target gNB. The target gNB may send a PATH SWITCH REQUEST message to the AMF to trigger 5GC to switch the DL data path towards the target gNB and to establish an NG-C interface instance towards the target gNB. The 5GC may switch the DL data path towards the target gNB. The UPF may send one or more “end marker” packets on the old path to the source gNB per PDU session/tunnel and may release U-plane/TNL resources (e.g., any U-plane/TNL resources) towards the source gNB. The AMF may confirm the PATH SWITCH REQUEST message with the a PATH SWITCH REQUEST ACKNOWLEDGE message. Based on reception of the PATH SWITCH REQUEST ACKNOWLEDGE message from the AMF, the target gNB may send the WTRU CONTEXT RELEASE to inform the source gNB about the success of the handover. The source gNB may release radio and C-plane related resources associated with the WTRU context. Ongoing data forwarding (e.g., any ongoing data forwarding) may continue.

Conditional HO and conditional PSCell change (CPC) may be provided. Handover failures may occur due to multiple reasons. One reason for failure may be too late measurement reports (e.g., the UL to the serving cell degrading before the WTRU was able to send a measurement report to the network indicating better alternative cells to handover the WTRU to) or too late handovers (e.g., WTRU able to send the measurements, but the DL of the serving cell degrading significantly and the network not able to send the HO command from the serving cell).

Conditional handover (CHO) and conditional PSCell addition/change (CPA/CPC, or collectively referred to as CPAC) may be used to reduce the likelihood of radio link failures (RLFs) and handover failures (HOFs).

Handover may be triggered by measurement reports, for example, even if there is nothing preventing the network from sending a HO command to the WTRU even without receiving a measurement report. For example, the WTRU may be configured with an A3 event that triggers a measurement report to be sent if the radio signal level/quality (e.g., reference signal radio power (RSRP), reference signal radio quality (RSRQ), etc.) of a neighbor cell becomes better than the primary serving cell (PCell) or the primary secondary serving cell (PSCell) in the case of dual connectivity (DC). The WTRU may monitor the serving and neighbor cells and may send a measurement report if conditions (e.g., measurement reporting condition or event condition) get fulfilled. When such a report is received, the network (e.g., current serving node/cell) may prepare the HO command (e.g., an RRC reconfiguration message with a reconfigurationWithSync) and may send it to the WTRU, which the WTRU may execute (e.g., immediately) resulting in the WTRU connecting to the target cell.

CHO may differ from handover based on one or more of the following: multiple handover targets may be prepared (e.g., as compared to only one target in the handover case); or the WTRU may not (e.g., immediately) execute the CHO as in the case of the handover. The WTRU may receive configuration information indicating (e.g., be configured with) triggering conditions such as a set of radio conditions (e.g., signal level quality, RSRP, RSRQ, thresholds), and the WTRU may execute the handover towards one of the targets if (e.g., only if) the triggering conditions are fulfilled.

The CHO command may be sent, for example, if the radio conditions towards the current serving cells are favorable, which may reduce the two main points of failure in handover (e.g., risk failing to send the measurement report (e.g., if the link quality to the current serving cell falls below acceptable levels when the measurement reports are triggered in normal handover) and the failure to receive the handover command (e.g., if the link quality to the current serving cell falls below acceptable levels after the WTRU has sent the measurement report, but before it has received the HO command)).

The triggering conditions for a CHO may be based on the radio quality of the serving cells and neighbor cells to trigger measurement reports. For example, the WTRU may receive configuration information indicating (e.g., be configured with) a CHO that has A3-like triggering conditions and associated HO command. The WTRU may monitor the current and serving cells and if the A3 triggering conditions are fulfilled, it may, e.g., instead of sending a measurement report, execute the associated HO command and switch its connection towards the target cell.

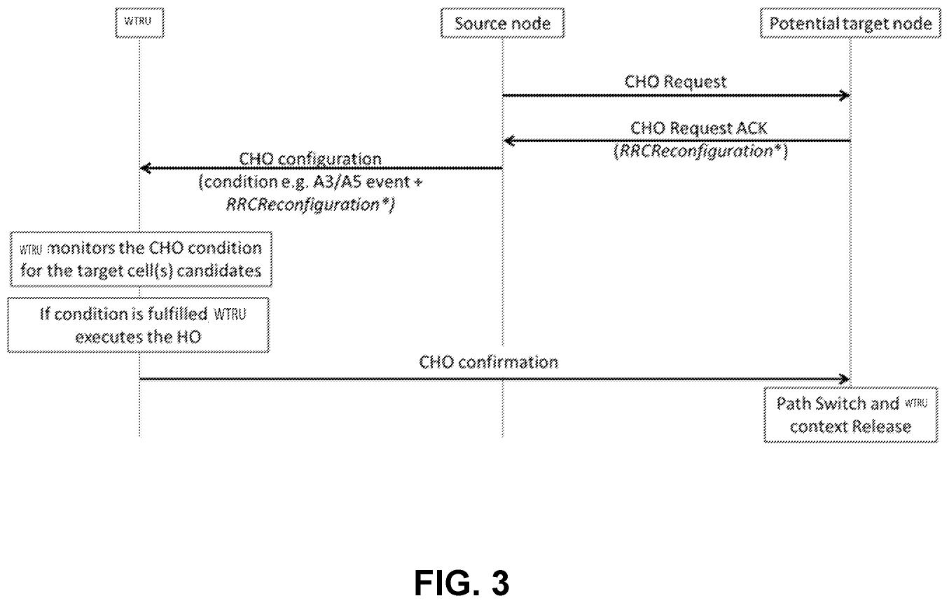

FIG. 3 shows an example conditional handover configuration and execution. CHO may help prevent unnecessary re-establishments in case of a radio link failure. For example, it may be assumed that the WTRU receives configuration information indicating (e.g., is configured with) multiple CHO targets and the WTRU experiences an RLF before the triggering conditions with the targets (e.g., any of the targets) gets fulfilled. Operations may have resulted in re-establishment procedure (e.g., RRC re-establishment procedure) that may have incurred considerable interruption time for the bearers of the WTRU. The WTRU may execute the HO command associated with this target cell directly instead of continuing with the full re-establishment procedure, for example, in the case of CHO, if the WTRU (e.g., after detecting an RLF) ends up a cell for which it has a CHO associated (e.g., the target cell is already prepared for it).

CPC and CPA may be extensions of CHO (e.g., in DC scenarios). A WTRU may receive configuration information indicating (e.g., be configured with) triggering conditions for PSCell change or addition. The WTRU may execute the associated PSCell change or PSCell add commands, for example, if the triggering conditions are fulfilled.

WTRU-to-network relays may be provided. Sidelink relaying may be provided. Relaying via ProSe WTRU to network relays may extend network coverage to an out of coverage WTRU by using PC5 (e.g., D2D) between an out of coverage WTRU and a WTRU-to-Network relay.

A ProSe WTRU-to-network relay may provide a (e.g., generic) L3 forwarding function that may relay a type (e.g., any type) of IP traffic between the remote WTRU and the network. One-to-one and one-to-many sidelink communications may be used between the remote WTRU(s) and the ProSe WTRU-to-network relay. For both the remote WTRU and relay WTRU, one (e.g., only one) single carrier (e.g., public safety ProSe carrier) operation may be supported (e.g., Uu and PC5 may be the same carrier for the relay/remote WTRU). The remote WTRU may be authorized (e.g., by upper layers) and may be in-coverage of the public safety ProSe carrier or out-of-coverage on a supported carrier (e.g., any supported carrier) including public safety ProSe carrier for WTRU-to-network relay discovery, (re)selection and communication. The ProSe WTRU-to-network relay may (e.g., always) be in-coverage of EUTRAN.

Sidelink may focus on supporting V2X related road safety services. The design may provide support for broadcast, groupcast and unicast communications in both out-of-coverage and in-network coverage scenarios. Sidelink-based relaying functionality may be applied to sidelink/network coverage extension and power efficiency improvement, for example, considering wider range of applications and services.

For coverage extension for sidelink-based communication, one or more of the following may apply. WTRU-to-network coverage extension may apply. For example, Uu coverage reachability may be used for WTRUs to reach a server in a PDN network or counterpart WTRU out of proximity area. WTRU-to-network relay techniques may use (e.g., be limited to) EUTRA-based technology and may not be applied to NR-based system(s) (e.g., for both NG-RAN and NR-based sidelink communication). WTRU-to-WTRU coverage extension may apply. For example, current proximity reachability may use (e.g., be limited to) single-hop sidelink link, either via EUTRA-based or NR-based sidelink technology. This may not be sufficient in the scenario where there is no Uu coverage, for example, considering the limited single-hop sidelink coverage.

Sidelink connectivity may be extended in NR framework to support the enhanced QoS requirements. Sidelink relaying may use single hop NR sidelink relays with one or more of the following considerations. A consideration may include mechanism(s) with minimum specification impact to support the requirements for sidelink-based WTRU-to-network and WTRU-to-WTRU relay, focusing on one or more of the following for layer-3 relay and layer-2 relay (e.g., RAN2): relay (re-)selection criterion and procedure; relay/remote WTRU authorization; QoS for relaying functionality; service continuity; security of relayed connection after SA3 has provided its conclusions; or impact on user plane protocol stack and control plane procedure (e.g., connection management of relayed connection). A consideration may include mechanism(s) to support upper layer operations of discovery model/procedure for sidelink relaying, assuming no physical layer channel/signal (e.g., RAN2).

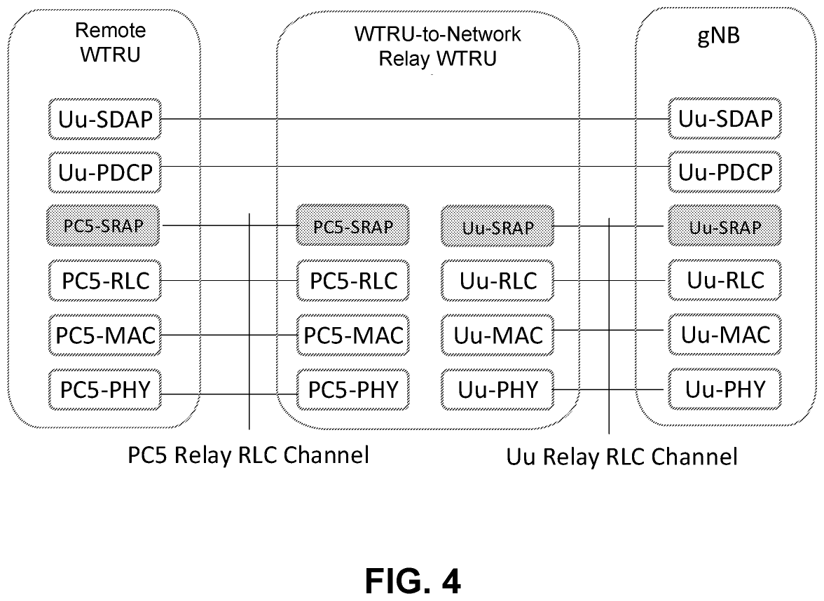

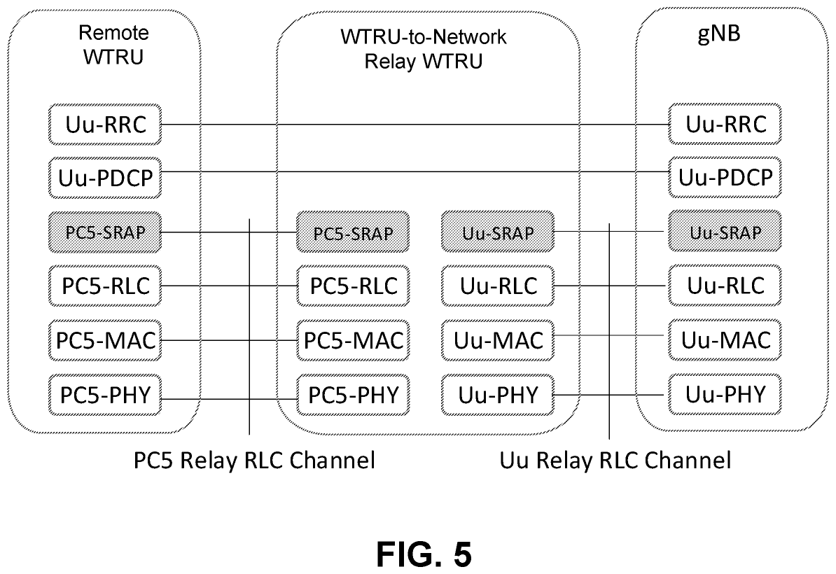

FIG. 4 shows an example user plane protocol stack for L2 WTRU-to-network relay. FIG. 5 shows an example control plane protocol stack for L2 WTRU-to-network relay. The protocol stacks for the user plane and control plane of L2 U2N relay architecture may be provided, as shown in FIGS. 4 and 5. The sidelink relay adaptation protocol (SRAP) sublayer may be placed above the RLC sublayer for both CP and UP at both the PC5 interface and Uu interface. The Uu SDAP, PDCP and RRC may be terminated between L2 U2N remote WTRU and gNB, while SRAP, RLC, MAC and PHY may terminated in a hop (e.g., each hop such as the link between the L2 U2N remote WTRU and L2 U2N relay WTRU and the link between L2 U2N relay WTRU and the gNB).

For L2 U2N relay, the SRAP sublayer over PC5 hop may be (e.g., may only be) for bearer mapping. The SRAP sublayer may not be present over PC5 hop for relaying the L2 U2N remote WTRU's message on Broadcast Control Channel (BCCH) and Paging Control Channel (PCCH). For L2 U2N remote WTRU's message on SRB0, the SRAP sublayer may not be present over PC5 hop, but the SRAP sublayer may be present over Uu hop for both DL and UL.

For L2 U2N relay for uplink, UL bearer mapping between ingress PC5 relay RLC channels for relaying and egress Uu Relay RLC channels over the L2 U2N relay WTRU Uu interface may be supported (e.g., by the Uu SRAP sublayer). For uplink relaying traffic, the different end-to-end RBs (e.g., SRBs or DRBs) of the same remote WTRU and/or different remote WTRUs may be multiplexed over the same Uu relay RLC channel. L2 U2N remote WTRU identification for the UL traffic may be supported (e.g., by the Uu SRAP sublayer). The identity information of the L2 U2N remote WTRU Uu radio bearer and a local remote WTRU ID may be included in the Uu SRAP header at UL for gNB to correlate the received packets for the specific PDCP entity associated with the right Uu radio bearer of a remote WTRU. UL bearer mapping between remote WTRU Uu Radio bearers and egress PC5 relay RLC channels may be supported (e.g., by the PC5 SRAP sublayer at the L2 U2N remote WTRU).

For L2 U2N relay for downlink, DL bearer mapping at gNB to map end-to-end radio bearer (e.g., SRB or DRB) of a remote WTRU into Uu relay RLC channel over a relay WTRU Uu interface may be supported (e.g., by the Uu SRAP sublayer). DL bearer mapping and data multiplexing between multiple end-to-end radio bearers (e.g., SRBs or DRBs) of a L2 U2N remote WTRU and/or different L2 U2N remote WTRUs and one Uu relay RLC channel over the relay WTRU Uu interface may be supported (e.g.,. by the Uu SRAP sublayer)). Remote WTRU identification for DL traffic may be supported (e.g., by the Uu SRAP sublayer). The identity information of the remote WTRU Uu radio bearer and a local remote WTRU ID may be included in the Uu SRAP header by the gNB at DL for the relay WTRU to map the received packets from the remote WTRU Uu radio bearer to its associated PC5 relay RLC channel. DL bearer mapping between ingress Uu relay RLC channels and egress PC5 relay RLC channels may be supported (e.g., by the PC5 SRAP sublayer at the relay WTRU). The received packets for the PDCP entity associated with the right Uu radio bearer of a remote WTRU may be correlated (e.g., by the PC5 SRAP sublayer at the remote WTRU), for example, based on the identity information included in the Uu SRAP header.

A local remote WTRU ID may be included in both the PC5 SRAP header and Uu SRAP header. The L2 U2N relay WTRU may be configured by the gNB with (e.g., receive configuration information indicating) the local remote WTRU ID to be used in SRAP header. The remote WTRU may obtain the local remote ID from the gNB, for example, via Uu messages (e.g., RRC messages including RRCSetup, RRCReconfiguration, RRCResume and RRCReestablishment). Uu DRB(s) and Uu SRB(s) may be mapped to different PC5 relay RLC channels and Uu relay RLC channels in both PC5 hop and Uu hop.

The gNB may avoid collision (e.g., it may be the gNB responsibility to avoid collision) on the usage of local remote WTRU ID. The gNB may update the local remote WTRU ID by sending the updated local remote ID via a message (e.g., an RRCReconfiguration message) to the relay WTRU. The serving gNB may perform the local remote WTRU ID update independent of the PC5 unicast link L2 ID update procedure.

Service continuity with SL relay may be provided. Service continuity in the context of SL relay may be supported (e.g., within the same gNB). Switching from an indirect link to a direct link may be supported. Switching from a direct link to an indirect link may be supported.

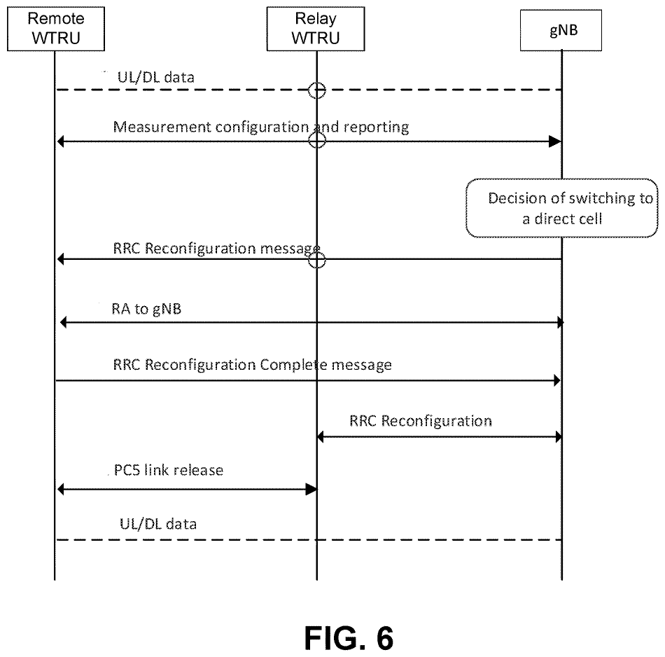

FIG. 6 shows an example procedure for a U2N remote WTRU switching to a direct Uu cell. Switching from an indirect to a direct path may be provided. For service continuity of L2 U2N relay, one or more of the following may be used, for example, in case of a U2N remote WTRU switching to direct path. The Uu measurement configuration and measurement report signaling procedures may be performed to evaluate both relay link measurement and Uu link measurement. The measurement results from the U2N remote WTRU may be reported, for example, if (e.g., when) configured measurement reporting criteria are met. The sidelink relay measurement report may include at least a U2N relay WTRU's source L2 ID, serving cell ID (e.g., NCGI), and sidelink measurement quantity information. The sidelink measurement quantity may be an SL-RSRP of the serving U2N relay WTRU. SD-RSRP may be used (e.g., as the sidelink measurement quantity) and if SL-RSRP is not available. The gNB may decide to switch the U2N Remote WTRU onto a direct Uu path. The gNB may send a reconfiguration message (e.g., an RRCReconfiguration message) to the U2N remote WTRU. The U2N remote WTRU may stop UP and CP transmission via a U2N relay WTRU, for example, after reception of the reconfiguration message (e.g., RRCReconfiguration message) from the gNB. The U2N remote WTRU may synchronize with the gNB and perform random access. The WTRU (e.g., U2N remote WTRU described herein) may send a reconfiguration complete message (e.g., RRCReconfigurationComplete message) to the gNB via direct path, for example, using the configuration provided in the reconfiguration message (e.g., RRCReconfiguration message). Based on this, the WTRU (e.g., U2N remote WTRU as described herein) may use a connection (e.g., the RRC connection) via the direct path to the gNB. The gNB may send the reconfiguration message (e.g., RRCReconfiguration message) to the U2N relay WTRU to reconfigure the connection between the U2N relay WTRU and the gNB. The reconfiguration message (e.g., RRCReconfiguration message) to the U2N relay WTRU may be sent a time (e.g., any time) after the gNB sends the configuration message (e.g., RRCconfiguration message) to the U2N remote WTRU as described herein based on gNB implementation (e.g., to release Uu and PC5 relay RLC channel configuration for relaying and bearer mapping configuration between PC5 RLC and Uu RLC). Either the U2N relay WTRU or the U2N remote WTRU may initiate the PC5 unicast link release (e.g., PC5-S). The timing to execute the link release may be up to WTRU implementation. The U2N relay WTRU may execute a side-link connection (e.g., PC5 connection) reconfiguration to release the PC5 relay RLC channel for relaying, for example, based on reception of the reconfiguration message (e.g., RRC reconfiguration) by the gNB as described herein. The WTRU (e.g., previous U2N remote WTRU) may execute a PC5 connection reconfiguration to release a PC5 relay RLC channel for relaying, for example, based on reception of the reconfiguration message (e.g., RRCReconfiguration) by the gNB (e.g., the gNB may send the RRCconfiguration message to the U2N remote WTRU as described herein). The data path may be switched from an indirect path to a direct path between the WTRU (e.g., previous U2N remote WTRU) and the gNB. The DL/UL lossless delivery during the path switch may be done, for example, based on a PDCP data recovery procedure. This may be executed a time (e.g., any time) after the U2N remote WTRU synchronizing with the gNB and performing random access as described herein. Switching the data path as described herein may be independent of the gNB sending the reconfiguration message (e.g., RRCReconfiguration) message to the U2N relay WTRU and either the U2N relay WTRU or the U2N remote WTRU initiating the PC5 unicast link release (e.g., both of which are described herein).

Switching from a direct to an indirect path may be provided. The gNB may select a U2N relay WTRU in an RRC state (e.g., any RRC state such as RRC_IDLE, RRC_INACTIVE, or RRC_CONNECTED) as a target U2N relay WTRU for a direct to indirect path switch.

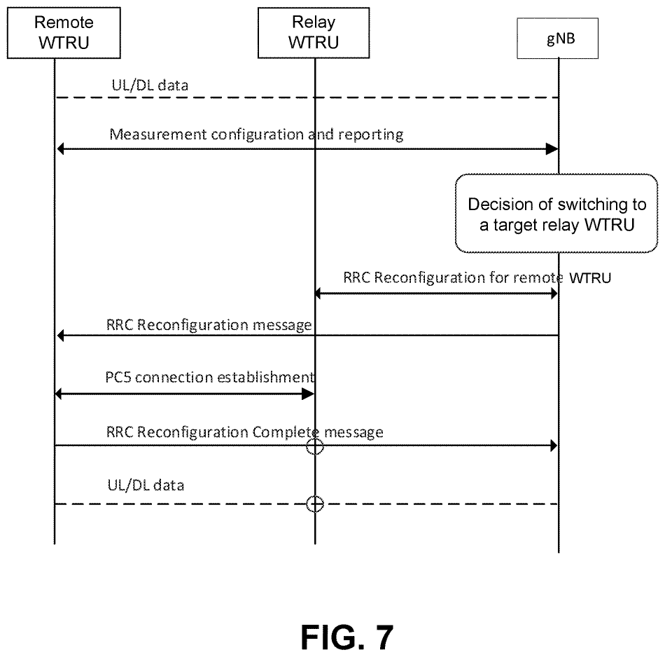

FIG. 7 shows an example procedure for a U2N remote WTRU switching to an indirect path. For service continuity of a L2 U2N remote WTRU, one or more of the following may be used (e.g., in case of the L2 U2N remote WTRU switching to an indirect path via a U2N relay WTRU in RRC_CONNECTED). The U2N remote WTRU may report one or more candidate U2N relay WTRU(s) and Uu measurements, for example, if (e.g., after) it measures/discovers the candidate U2N relay WTRU(s). The WTRU may filter the appropriate U2N relay WTRU(s) based on relay selection criteria before reporting. The WTRU may report (e.g., report only) the U2N relay WTRU candidate(s) that fulfil criteria (e.g., the higher layer criteria). The reporting may include at least one of the U2N relay WTRU ID, U2N relay WTRU's serving cell ID, or sidelink measurement quantity information. The sidelink measurement quantity may be the SL-RSRP of the candidate U2N relay WTRU. SD-RSRP may be used (e.g., as the sidelink measurement quantity), for example, if SL-RSRP is not available,. The gNB may (e.g., decide to) switch the U2N remote WTRU to a target U2N relay WTRU. The gNB may send a reconfiguration message (e.g., an RRCReconfiguration message) to the target U2N relay WTRU. The reconfiguration message may include at least a remote WTRU's local ID and L2 ID, Uu and PC5 relay RLC channel configuration for relaying, and/or bearer mapping configuration. The gNB may send the reconfiguration message (e.g., RRCReconfiguration message) to the U2N remote WTRU. The contents in the reconfiguration message (e.g., RRCReconfiguration message) may include at least a U2N relay WTRU ID, PC5 relay RLC channel configuration for relay traffic and/or the associated end-to-end radio bearer(s). The U2N remote WTRU may stop UP and CP transmission over Uu after reception of the RRCReconfiguration message from the gNB. The U2N remote WTRU may establish a PC5 connection with the target U2N relay WTRU. The U2N remote WTRU may complete the path switch procedure by sending the RRCReconfiguration Complete message to the gNB via the relay WTRU. The data path may be switched from a direct path to an indirect path between the U2N remote WTRU and the gNB.

The U2N remote WTRU may establish a PC5 link with the U2N relay WTRU and send the RRCReconfiguration Complete message via the U2N relay WTRU (e.g., which may trigger the U2N relay WTRU to enter RRC_CONNECTED state), for example, in cases where the selected U2N relay WTRU for direct to indirect path switch is in RRC_IDLE or RRC_INACTIVE (e.g., after receiving the path switch command). The procedure for U2N remote WTRU switching to indirect path in FIG. 7 may be applied for the case where the selected U2N relay WTRU for direct to indirect path switch is in RRC_IDLE or RRC_INACTIVE (e.g., with the exception that when the U2N remote WTRU establishes the PC5 connection with the target U2N relay WTRU, the gNB decides to switch the U2N remote WTRU to a target U2N relay WTRU).

Service continuity with SL relay may be provided. A feature may expand the scenarios for service continuity.

Mechanisms to enhance service continuity for single-hop Layer-2 WTRU-to-network relay may be supported for one or more of the following scenarios (e.g., RAN2 or RAN3): inter-gNB indirect-to-direct path switching (e.g., “remote WTRU↔relay WTRU A↔gNB X” to “remote WTRU↔gNB Y”); inter-gNB direct-to-indirect path switching (e.g., “remote WTRU↔gNB X” to “remote WTRU↔relay WTRU A↔gNB Y”); intra-gNB indirect-to-indirect path switching (e.g., “remote WTRU↔relay WTRU A↔gNB X” to “remote WTRU↔relay WTRU B↔gNB X”); or inter-gNB indirect-to-indirect path switching (e.g., “remote WTRU↔relay WTRU A↔gNB X” to “remote WTRU↔relay WTRU B↔gNB Y”). Inter-gNB indirect-to-indirect path switching may be supported by reusing techniques for the other scenarios without specific optimizations.

As described herein, CHO may reduce the occurrence of handover failures due to too late measurements or too late handover commands. However, CHO may use (e.g., require) resource reservation at the target node and as such may not be available at a time (e.g., all the time).

Techniques to take advantage of SL connectivity to a relay WTRU to make handovers more robust in scenarios where CHO may not be feasible (e.g., due to network resource and/or WTRU/network node capability limitations) may be provided. Utilizing connectivity via a SL relay to increase the robustness of HOs without the use of CHO may be performed (e.g., as described herein).

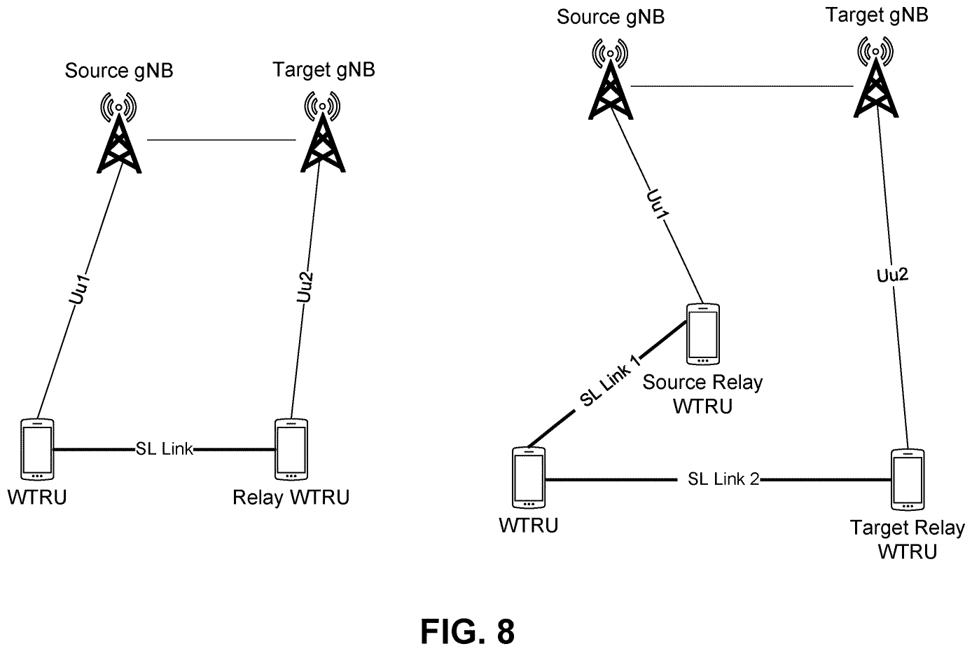

Techniques described herein may apply in the scenario where a HO is performed from a direct or indirect link from one source gNB to an indirect link of another gNB, as shown in FIG. 8.

FIG. 8 shows an example HO from a direct or indirect link from a source gNB to an indirect link of another gNB. The techniques may be applicable to other scenarios such as multihop scenarios (e.g., where the source and/or relay WTRU is further connected to a parent relay WTRU which is connected to the gNB).

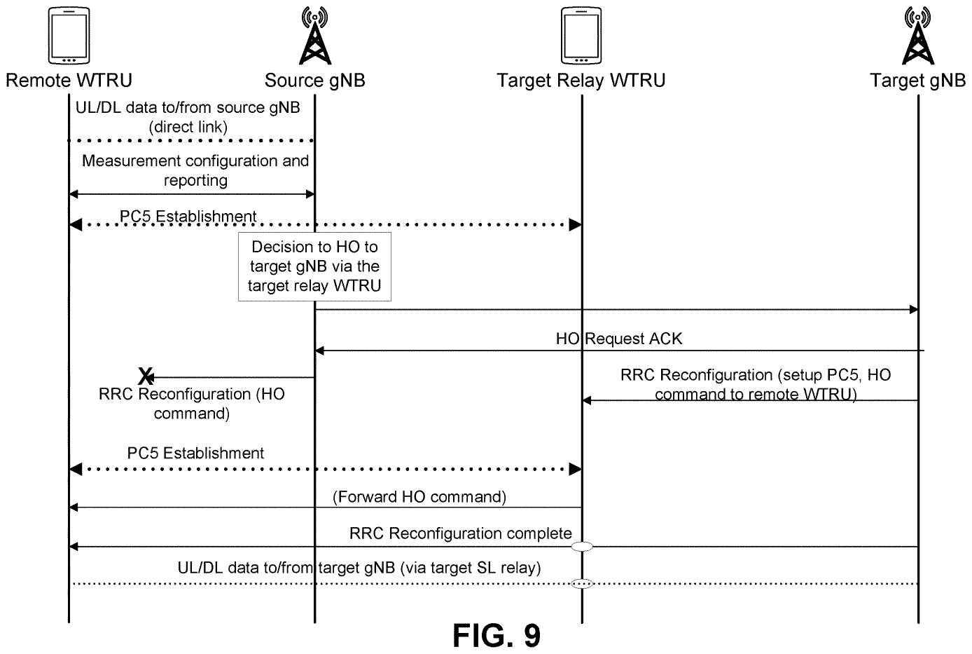

Sending an HO command via the target relay WTRU where the relay WTRU is in CONNECTED state may be provided. The messages in bold shown in FIG. 9 may have enhancements (e.g., information included) or their triggering may be performed using a technique described herein.

The WTRU may receive a first message from a base station. The first message may include an HO command for a remote WTRU. The WTRU may establish a side-link connection to the remote WTRU. The WTRU may send a second message to the remote WTRU via the side-link connection. The second message may include the HO command for the remote WTRU. The side-link connection to the remote WTRU may be a PC5 side-link connection. The WTRU may receive information, from the base station, for example, that may indicate an identity of the remote WTRU. The WTRU may receive configuration information indicating (e.g., be configured) to establish the side-link connection to the remote WTRU based on the received information. The first message may include the information indicative of the identity of the remote WTRU. The first message may be received via a first connection (e.g., an existing RRC connection) to the base station. The WTRU may establish a second connection (e.g., an RRC connection) to the base station based on an indication received from the remote WTRU via the side-link connection. The first message may be received via the connection (e.g., RRC connection) to the base station established based on the indication received from the remote WTRU.

In examples, a WTRU may establish a side-link connection to a relay WTRU concurrent with a connection (e.g., RRC connection) with a source base station. The WTRU may receive a message, via the side-link connection, from a target base station. The message may include an HO command indicating an HO from the source base station to the target base station. The WTRU may establish the side-link connection to the relay WTRU based on a triggering event having been met. The triggering event may be based on a measurement report to the source base station indicating that a side-link radio signal reference power (SL-RSRP) towards the relay WTRU is greater than a threshold. The message may be a first message. The WTRU may send a second message, via the side-link connection, to the relay WTRU. The second message may contain information that causes the relay WTRU to establish a connection (e.g., an RRC connection) with the target base station.

A device may send a message to a relay WTRU connected to a target base station. The message may include an HO command intended for a remote WTRU connected to a source base station to handover from the source base station to the target base station.

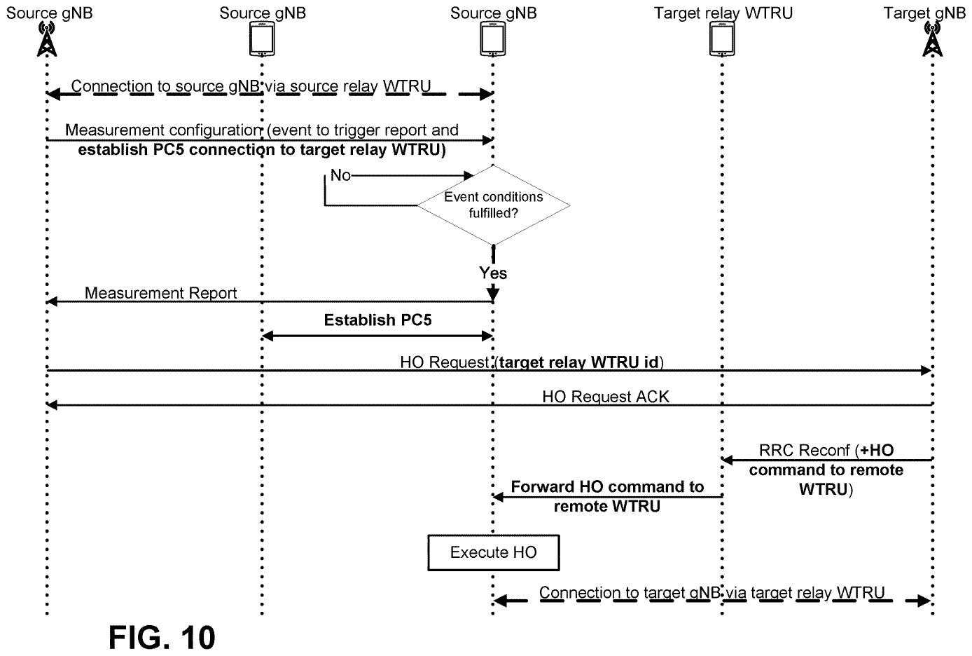

FIG. 9 shows an example of sending an HO command via the target relay WTRU. A remote WTRU may be served by a direct link to a source gNB. FIG. 10 shows an example flow of HO based on a measurement reporting event and an event condition. The remote WTRU may receive configuration information indicating to (e.g., be configured to) measure neighbors (e.g., direct links and/or indirect links via SL relays). For example, the configuration information may indicate a measurement reporting condition and/or a sidelink connection establishment condition. The measurement reporting condition may be satisfied, for example, if a radio measurement quality (e.g., RSRP, signal level) associated with a neighboring network node (e.g., target network node) being greater than a radio measurement quality (e.g., RSRP, signal level) associated with the source network node. The radio measurement quality associated with the network nodes may be an aggregated RSRP. For example, the radio measurement quality associated with the source network node may be the aggregate of the RSRP of a connection between a source relay WTRU and the source relay WTRU and the RSRP of a sidelink connection between the remote WTRU and the source relay WTRU. The radio measurement quality associated with a target network node may be the aggregate of the RSRP of a connection between a target relay WTRU and the target network node and the RSRP of a sidelink connection between the remote WTRU and the target relay WTRU. The sidelink connection establishment connection condition may be associated with a sidelink RSRP (SL-RSRP). For example, a sidelink connection establishment condition may be determined to be satisfied based on a SL-RSRP associated with a relay WTRU being greater than a threshold. The WTRU may perform the measurements and send a measurement report when the measurement report triggering conditions are fulfilled (e.g., based on a determination that the measurement reporting condition is satisfied). The remote WTRU may receive (e.g., by the source gNB) configuration information indicating (e.g., be pre-configured) to initiate a PC5 (e.g., sidelink) connection with one or more target relay WTRUs (e.g., if it is not established already) based on fulfillment of the condition(s) (e.g., sidelink connection establishment condition, or measurement reporting condition that triggered the measurement report as described herein). For example, the remote WTRU may determine one or more candidate target relay WTRUs that satisfy the sidelink connection establishment condition(s). For example, the remote WTRU may be configured to initiate a PC5 (e.g., sidelink) connection to one or more of the candidate target relay WTRUs (e.g., based on the determination that the one or more candidate target relay WTRUs satisfy the sidelink connection establishment condition(s)) that are indicated in the measurement report it has sent. For example, the WTRU may be configured to initiate the PC5 connection to one or more of the following: to the candidate target relays (e.g., all the candidate target relays) included in the measurement report; to the top n candidate target relays; to the candidate target relays (e.g., all the candidate target relays) that have SL-RSRP above a certain threshold; to the top n candidate target relays that fulfill a SL-RSRP threshold; to the best candidate target relay; etc. For example, the remote WTRU may send a request to establish a sidelink connection with a first relay WTRU and a second relay WTRU (e.g., that satisfy the sidelink connection establishment condition). The WTRU may receive a connection establishment message from the first and/or second relay WTRU(s), for example, that indicate that a sidelink connection with the first and/or second relay WTRU(s) have been established. The source gNB (e.g., based on a measurement report received from the remote WTRU) may decide to handover the WTRU to a target gNB. The source gNB may communicate this to the target gNB via an HO request message (e.g., as shown in FIG. 10). The source gNB may include an indication (e.g., identity) of one candidate target relay WTRU in the HO request message. In examples, the HO request message may include an indication (e.g., identities) of multiple target relay WTRU candidates (e.g., including the SL measurement results between the remote WTRU and each candidate relay WTRU), e.g., as shown in FIG. 10. In examples, the HO request message may include an indication to the target gNB requesting the target gNB to forward the HO command directly to the WTRU via a target relay WTRU (e.g., as shown in FIG. 10). The HO request message may include an identity of the remote WTRU over the SL. The target gNB may perform the admission control of the WTRU. In examples, the target gNB (e.g., if it was provided with multiple candidate relay WTRUs) may choose one of the target relay WTRUs for the indirect link (e.g., considering the indicated SL measurement between the candidate relay WTRUs and the remote WTRU included in the HO request and the Uu link between the target gNB and the candidate relay WTRUs). The target gNB may prepare the HO command (e.g., an RRC reconfiguration message) to the remote WTRU that indicates a relayed link is to be setup via the chosen target relay WTRU. The target gNB may send an HO request ACK message to the source gNB, including the HO command to the WTRU (e.g., as shown in FIG. 10). The target gNB may include an indication in the HO request ACK that it will send (e.g., or has already sent) the HO command directly to the WTRU, as requested in the HO request message (e.g., as described herein) by the source gNB. In examples, the target gNB may send a message (e.g., RRC reconfiguration message) to the chosen target relay WTRU, including one or more of the following: an identity of the remote WTRU (e.g., L2 WTRU ID over PC5); indication to setup a PC5 link towards the indicated remoted WTRU; the HO command (e.g., RRC reconfiguration message) that is to be forwarded to the remote WTRU; etc. The source gNB, based on receiving the HO request ACK from the target, may forward the HO command to the WTRU. To illustrate the robustness of this technique in the scenario being described herein, it may be assumed that the source link has already been lost and the HO command may not be received via the source link. In examples, the source gNB, based on receiving an indication in the HO request ACK that the target gNB has sent or is going to send the HO command to the WTRU, may refrain from sending (e.g., refrain from attempting to send or not attempt to send) the HO command to the WTRU (e.g., forwarding the HO command may be skipped). The target relay WTRU may perform one or more of the following (e.g., based on receiving the reconfiguration message from the target gNB): initiate a PC5 link (e.g., sidelink) establishment to the indicated remote WTRU (e.g., if it is not set up already); or if (e.g., once) the PC5 link (e.g., sidelink) is established or if it is already established, the relay WTRU may forward (e.g., transparently forward) the HO command to the remote WTRU. In examples, the forwarding of the HO command may be performed as part of the PC5 link establishment. The remote WTRU may execute the received HO command (e.g., establish connection with the target network node/gNB (e.g., via a direct Uu link, via an indirect SL link via a first relay WTRU that sent the HO command, or via an indirect SL link via a second relay WTRU). The remote WTRU may send the HO reconfiguration complete to the target gNB, for example, via the target SL relay WTRU. UL/DL data transmission/reception may resume via the indirect target link. Different techniques/messages described herein may not be performed in the order described, and some messages may be combined or split into multiple messages.

Aspects related to a target relay WTRU in IDLE/INACTIVE may be provided. In examples, the target relay WTRU may be in IDLE/INACTIVE state (e.g., camping in a cell that belongs to target gNB in RRC_IDLE or RRC_INACTIVE).

In examples, during or immediately after the PC5 establishment initiated before the HO is performed (e.g., as described herein), the target relay WTRU may use this as an indication to trigger to establish or resume the RRC connection towards the target gNB.

In examples, the PC5 establishment request from the remote WTRU may include an indication to the relay WTRU to establish or resume the relay WTRU's RRC connection towards the target gNB.

In examples, the relay WTRU may include an establishment cause value (e.g., RRC establishment cause value in the case of RRC setup) or resume cause value (e.g., RRC resume cause value in the case of RRC resume) that indicates the reason behind the establishment/resume (e.g., relay WTRU establishing the connection on anticipation of a remote WTRU that soon will be connected to the target gNB via the relay WTRU).

A relay WTRU may be paged by/via the target gNB (e.g., RAN paging if is in INACTIVE mode or CN paging if it is in IDLE mode) to transition it to a CONNECTED state. The target gNB may decide to do this based on determining/deciding the remote WTRU is to be handed over to an indirect link via the relay WTRU and the relay WTRU is in IDLE/INACTIVE state.

In examples, information may be included in the paging message that indicates to the relay WTRU to initiate the PC5 link towards the remote WTRU (e.g., remote WTRU L2 identity information included in the paging message).

Aspects related to the target gNB deciding to set up a direct link instead of a relayed link may be provided. The target gNB may decide to handover the WTRU to a direct link, even though the source has indicated one or more candidate relay WTRUs (e.g., if the Uu link between the candidate relay and the target gNB is in bad radio conditions, if the candidate relay WTRU is already relaying many remote WTRUS and thus possible to experience buffering/load issues, etc.). In examples, the HO command may be forwarded via a candidate SL relay WTRU (e.g., even if the target gNB has decided to use the direct link). The remote WTRU or the relay WTRU may (e.g., be configured to) setup this link (e.g., at least temporarily) so that the HO command may be forwarded via the PC5 link, for example, if a PC5 link is not already available between the remote WTRU and the relay WTRU. The remote WTRU may end up setting a direct link towards the target gNB, for example, because (e.g., since) the HO command includes configuration information (e.g., configuration information only) about the setting of the direct link towards the target gNB. The PC5 link may be released once the direct link to the target gNB is established.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-20. (canceled)

21. A remote wireless transmit/receive unit (WTRU), comprising:
a processor configured to:
receive configuration information, wherein the configuration information indicates a measurement reporting condition and a sidelink connection establishment condition;
based on a determination that the measurement reporting condition is satisfied, send a measurement report to a source network node,
determine that a relay WTRU connected to a target network node satisfies the sidelink connection establishment condition, and
based on the determination that the relay WTRU satisfies the sidelink connection establishment condition, send a request to establish a sidelink connection with the relay WTRU;
receive a handover command from the target network node, via the relay WTRU, wherein the handover command indicates the target network node; and
establish a connection associated with the target network node based on the handover command.

22. The remote WTRU of claim 21, wherein the measurement reporting condition comprises a radio measurement quality associated with a neighboring network node being greater than a radio measurement quality associated with the source network node.

23. The remote WTRU of claim 22, wherein the radio measurement quality associated with the neighboring network node and the radio measurement quality associated with the source network node are respective reference signal received powers (RSRPs) or respective reference signal received qualities (RSRQs).

24. The remote WTRU of claim 22, wherein the relay WTRU is a target relay WTRU, wherein the radio measurement quality associated with the neighboring network node is a first aggregated reference signal received power (RSRP), wherein the radio measurement quality associated with the source network node is a second aggregated RSRP, wherein the first aggregated RSRP is associated with a sidelink connection with a source relay WTRU and a first Uu connection between the source relay WTRU and the source network node, and wherein the second aggregated RSRP is associated with a sidelink connection with the target relay WTRU and a second Uu connection between the target relay WTRU and the target network node.

25. The remote WTRU of claim 21, wherein the relay WTRU is a first relay WTRU, and wherein the established connection associated with the target network node is one of a direct Uu link with the target network node, an indirect link via a sidelink with the first relay WTRU, or an indirect link via a sidelink with a second relay WTRU.

26. The remote WTRU of claim 21, wherein the measurement reporting condition comprises a signal level of the source network node being less than a first threshold and a signal level of the target network node being greater than a second threshold, and wherein the configuration information further indicates a list of candidate relay WTRUs, and wherein the determination that the relay WTRU satisfies the sidelink connection establishment condition comprises a determination that the relay WTRU is included in the list of candidate relay WTRUs.

27. The remote WTRU of claim 21, wherein the processor is further configured to:
determine that a sidelink reference signal received power (SL-RSRP) associated with the relay WTRU is greater than a threshold, wherein the determination that the relay WTRU satisfies the sidelink connection establishment condition comprises the determination that the SL-RSRP associated with the relay WTRU is greater than the threshold.

28. The remote WTRU of claim 21, wherein the sidelink connection to the relay WTRU is a PC5 sidelink connection.

29. The remote WTRU of claim 21, wherein the relay WTRU is a first relay WTRU, wherein the handover command is a first handover command, and wherein the processor is further configured to:
determine that a second relay WTRU satisfies the sidelink connection establishment condition;
based on the determination that the second relay WTRU satisfies the sidelink connection establishment condition, send a request establish a sidelink connection to the second relay WTRU; and
receive a second handover command via the second relay WTRU, wherein in the second handover command indicates the target network node, wherein the establishment of the connection associated with the target network node is further based on the second handover command.

30. The remote WTRU of claim 21, wherein the processor is further configured to:
receive a connection establishment message from the relay WTRU, wherein the connection establishment message indicates that a sidelink connection with the relay WTRU has been established; and
send, to the target network node, an indication indicating that handover reconfiguration is complete, wherein the indication is sent via the sidelink connection with the relay WTRU.

31. A method comprising:
receiving configuration information, wherein the configuration information indicates a measurement reporting condition and a sidelink connection establishment condition;
based on a determination that the measurement reporting condition is satisfied,
sending a measurement report to a source network node,
determining that a relay WTRU connected to a target network node satisfies the sidelink connection establishment condition, and
based on the determination that the relay WTRU satisfies the sidelink connection establishment condition, sending a request to establish a sidelink connection with the relay WTRU;
receiving a handover command from the target network node, via the relay WTRU, wherein the handover command indicates the target network node; and
establishing a connection associated with the target network node based on the handover command.

32. The method of claim 31, wherein the measurement reporting condition comprises a radio measurement quality associated with a neighboring network node being greater than a radio measurement quality associated with the source network node.

33. The method of claim 32, wherein the radio measurement quality associated with the neighboring network node and the radio measurement quality associated with the source network node are respective reference signal received powers (RSRPs) or respective reference signal received qualities (RSRQs).

34. The method of claim 32, wherein the relay WTRU is a target relay WTRU, wherein the radio measurement quality associated with the neighboring network node is a first aggregated reference signal received power (RSRP), wherein the radio measurement quality associated with the source network node is a second aggregated RSRP, wherein the first aggregated RSRP is associated with a sidelink connection with a source relay WTRU and a first Uu connection between the source relay WTRU and the source network node, and wherein the second aggregated RSRP is associated with a sidelink connection with the target relay WTRU and a second Uu connection between the target relay WTRU and the target network node.

35. The method of claim 31, wherein the relay WTRU is a first relay WTRU, and wherein the established connection associated with the target network node is one of a direct Uu link with the target network node, an indirect link via a sidelink with the first relay WTRU, or an indirect link via a sidelink with a second relay WTRU.

36. The method of claim 31, wherein the measurement reporting condition comprises a signal level of the source network node being less than a first threshold and a signal level of the target network node being greater than a second threshold, and wherein the configuration information further indicates a list of candidate relay WTRUs, and wherein the determination that the relay WTRU satisfies the sidelink connection establishment condition comprises a determination that the relay WTRU is included in the list of candidate relay WTRUS.

37. The method of claim 31, wherein the method further comprises:
determining that a sidelink reference signal received power (SL-RSRP) associated with the relay WTRU is greater than a threshold, wherein the determination that the relay WTRU satisfies the sidelink connection establishment condition comprises the determination that the SL-RSRP associated with the relay WTRU is greater than the threshold.

38. The method of claim 31, wherein the sidelink connection to the relay WTRU is a PC5 sidelink connection.

39. The method of claim 31, wherein the relay WTRU is a first relay WTRU, wherein the handover command is a first handover command, and wherein the method further comprises:
determining that a second relay WTRU satisfies the sidelink connection establishment condition;
based on the determination that the second relay WTRU satisfies the sidelink connection establishment condition, sending a request establish a sidelink connection to the second relay WTRU; and
receiving a second handover command via the second relay WTRU, wherein in the second handover command indicates the target network node, wherein the establishment of the connection associated with the target network node is further based on the second handover command.

40. The method of claim 31, wherein the method further comprises:
receiving a connection establishment message from the relay WTRU, wherein the connection establishment message indicates that a sidelink connection with the relay WTRU has been established; and
sending, to the target network node, an indication indicating that handover reconfiguration is complete, wherein the indication is sent via the sidelink connection with the relay WTRU.
